(19) United States
(12) Patent Application Publication
(10) Pub. No.: US 2007/0249514 A1
(43) Pub. Date: Oct. 25, 2007

(54) Rheology modifying systems and detersive compositions comprising same

(75) Inventor: Sanjeev Midha, Mason, OH (US)

Correspondence Address: THE PROCTER & GAMBLE COMPANY;INTELLECTUAL PROPERTY DIVISION - WEST BLDG., WINTON HILL BUSINESS CENTER - BOX 412, 6250 CENTER HILL AVENUE, CINCINNATI, OH, 45224, US

(73) Assignee: The Procter & Gamble Company

(21) Appl. No.: 11/787,711

(22) Filed: Apr. 17, 2007

Related U.S. Application Data
(60) Provisional application No. 60/793,065, filed on Apr. 19, 2006.

(51) Int. Cl. C11D 3/37

(52) U.S. Cl. 510/475

(57) ABSTRACT

Rheology modifying systems and detersive compositions comprising such systems are disclosed herein. The rheology modifying systems comprise a combination of a clay with an anionic polymer or a cellulosic polymer.

### CROSS REFERENCE TO RELATED APPLICATION(S)

This application claims the benefit of U.S. Provisional Application No. 60/793,065, filed Apr. 19, 2006.

### FIELD OF THE INVENTION

The present invention is directed to rheology modifying systems and detersive compositions comprising the same. Detersive compositions contemplated by the present invention include, but are not limited to, mammalian (human and domestic animals) shampoos, body wash products, dish care products, laundry detergents, and other fabric and home care products.

### BACKGROUND OF THE INVENTION

Many detersive compositions employ rheology modifying systems to impart a desired viscosity or to suspend particles, for example. Rheology modifying systems that are currently known however can have disadvantages. One disadvantage is that the rheology modifiers can negatively interact with surfactants in the compositions such that desired lather levels and later profiles are unmet. Furthermore, in some detersive compositions, such as, for example, shampoos, the desired viscosity varies throughout the in-use experience. When using a shampoo, a user wants a product that pours easily out of its container, has good texture/feel in their hands, spreads nicely in their hair, and then satisfactorily rinses out of their hair. Whereas existing rheology modifying systems may operate effectively at one stage, they may operate poorly at another stage.

Some detersive compositions are devoid of rheology modifying systems, and instead rely on the included surfactants and co-surfactants to provide the desired viscosity profiles. The compositions can however become so thin as to be unworkable when surfactant levels are adjusted.

Accordingly, improved rheology modifying systems are needed.

### SUMMARY OF THE INVENTION

Detersive compositions are provided by the present invention. In accordance with one of the preferred embodiments, there has now been provided a detersive composition including a surfactant, and a rheology modifying system comprising the combination of a hectorite and a polymer comprising cyclic alpha, beta unsaturated anhydrides and vinyl ether monomers.

In accordance with another preferred embodiment, there has now been provided a detersive composition including a surfactant, and a rheology modifying system comprising the combination of a hectorite and a water-swellable polymer comprising cellulose ethers.

In accordance with another preferred embodiment, there has now been provided a detersive composition including a rheology modifying system comprising a combination of a clay with an anionic polymer or a cellulosic polymer. The detersive composition has total surfactant level of less than or equal to about 14% by weight of the composition, and a viscosity of from about 7 Pa-sec to about 1,000 Pa-sec at a shear rate of 0.05 sec-1, and measured at 25° C.

In accordance with yet another preferred embodiment, there has now been provided a detersive composition including a rheology modifying system comprising a combination of a clay with an anionic polymer or a cellulosic polymer. The clay and the polymer collectively are included in an amount of from about 0.1% to about 1% by weight of the composition. And the composition has a viscosity of from about 7 Pa-sec to about 1,000 Pa-sec at a shear rate of 0.05 sec-1, and measured at 25° C.

In accordance with another preferred embodiment, there has now been provided a detersive composition including a rheology modifying system comprising a combination of a clay with an anionic polymer or a cellulosic polymer. The composition has a total surfactant level of less than or equal to about 14% by weight of the composition, a viscosity of from about 7 Pa-sec to about 1,000 Pa-sec at a shear rate of 0.05 sec-1, and measured at 25° C., and a lather index of from about 1 to about 2.

### DETAILED DESCRIPTION OF THE INVENTION

The present invention may be understood more readily by reference to the following detailed description of illustrative and preferred embodiments. It is to be understood that the scope of the claims is not limited to the specific ingredients, methods, conditions, devices, or parameters described herein, and that the terminology used herein is not intended to be limiting of the claimed invention. Also, as used in the specification, including the appended claims, the singular forms “a,” “an,” and “the” include the plural, and reference to a particular numerical value includes at least that particular value, unless the context clearly dictates otherwise. When a range of values is expressed, another embodiment includes from the one particular value and/or to the other particular value. Similarly, when values are expressed as approximations, by use of the antecedent basis “about,” it will be understood that the particular values forms another embodiment. All ranges are inclusive and combinable.

All percentages and ratios used herein are by weight of the total composition and all measurements made are at 25° C., unless otherwise designated.

“A crosslinked copolymer of maleic anhydride and vinyl methyl ether,” as this polymer is referenced herein, is as a raw material prior to its employment in detersive compositions of the present invention. That is, the polymer is hydrolyzed in water, and will no longer be an anhydride.

The compositions of the present invention can comprise, consist essentially of, or consist of, the essential components as well as optional ingredients described herein. As used herein, “consisting essentially of” means that the composition or component may include additional ingredients, but only if the additional ingredients do not materially alter the basic and novel characteristics of the claimed compositions or methods.

The present invention is directed to rheology modifying systems and detersive compositions comprising the same.

### I. RHEOLOGY MODIFYING SYSTEMS

The rheology modifying systems of the present invention comprise a combination of a clay with an anionic polymer or a cellulosic polymer. The rheology modifying systems are generally included in the detersive compositions at a level of from about 0.01% to about 5%, and preferably at level of from about 0.01% to about 2%, by weight of the composition. In some exemplary embodiments, each of the components of the rheology modifying system (i.e., the clay or the polymer) are included in an amount from about 0.01% to about 0.1%, 0.25%, 0.5%, by weight of the composition. It is to be understood that different inclusion levels of the rheology modifying systems described herein may be included in detersive compositions, and that claims which do not recite specific inclusion levels are not limited to the particular ranges cited herein.

A. Clays

A variety of different natural and synthetic clays may be suitable for use in the present invention, including hectorite and bentonite clays, for example. Preferable clays include synthetic hectorites that are made from silicates, magnesium, sodium, and lithium salts. Examples of synthetic hectorites are sodium magnesium silicate (and) tetrasodium pyrophosphate (Laponite XLS, Southern Clay, Rockwood Specialties). Other useful synthetic hectorites are Laponite D, and XLG also from Southern Clay, Rockwood Specialities. Other suitable hectorites (magnesium aluminum silicates) are sold under the tradename Veegums (R.T. Vanderbilt) and Gel Whites (Southern Clay). It is to be understood that other clays, besides hectorites and bentonite clays, may be employed in the present invention.

Properties and behaviors of clays are described in the book: “Rheological Properties of Cosmetics and Toiletries,” Edited by Dennis Laba (Marcel Dekker, Inc.; ISBN 0-8247-9090-1), page 123.

B. Anionic Polymers

Exemplary anionic polymers for use in the rheology modifying systems of the present invention include, but are not limited to, synthetic polymers, crosslinked polymers, block polymers, oligomers, and copolymers thereof. Specific exemplary anionic polymers are described in greater detail below.

The anionic polymer may comprise a first monomer and a second monomer, wherein the first monomer is selected from the group consisting of acrylic acid, salts of acrylic acid, C1-C4 alkyl-substituted acrylic acid, salts of C1-C4 alkyl-substituted acrylic acid, C1-C4 alkyl esters of acrylic acid, C1-C4 alkyl esters of C1-C4 alkyl-substituted acrylic acid, maleic anhydride, and mixtures thereof. The salts of the acids described in the previous sentence may be selected from the group consisting of alkali metal salts, alkaline metal salts, ammonium salts, and mono-, di-, tri-, and tetra-alkyl ammonium salts. The C1-C4 alkyl-substituted acrylic acids may include methacrylic acids, ethacrylic acids, and the like, wherein the alkyl substituent can be either on the C2 or C3 position of the acid molecule. And the C1-C4 alkyl esters can include methyl and ethyl esters as well as branched C3 and C4 esters.

In some embodiments, the anionic polymers are crosslinked, and further comprise a crosslinking agent. Examples of such polymers are more fully described in U.S. Pat. Nos. 5,087,445; 4,509,949; and 2,798,053. See also, “CTFA International Cosmetic Ingredient Dictionary,” fourth edition, 1991, pp. 12 and 80.

A representative, non-limiting list of suitable anionic polymers includes polyacrylates, polymethacrylates, polyacrylamides, polymethacrylamides, polyurethanes, polyesters, polyethers, Pemulen TR-1, Pemulen TR-2, ETD 2020, Carbopol 1382 (Acrylates/C10-30 alkyl acrylate crosspolymer-Noveon), Carbopol 940, Carbopol 980, Carbopol 954, Carbopol Aqua SF-1, Carbomer, Acrylates/Acrylamide Copolymers, Acrylates Copolymers, Acrylates Crosspolymers, Acrylates/Acrylamide Crosspolymers, Acrylates/Alkyl Acrylates Copolymers, Acrylates/Alkyl Acrylates Crosspolymers, Acrylates/VA Copolymers, Acrylates/VA Crosspolymers, Aminoalkyl and aminoalkanol Acrylates Copolymers, Acrylates/Dimethicone Copolymers, Acrylates/Dimethicone Crosspolymers, Acrylamide/Acrylate Copolymers, Acrylamide/Acrylate Crosspolymers, Ammonium Polyacrylate, Ammonium Acrylates Copolymer, Sodium Polyacrylate Starch, TEA-Acrylates Copolymers, TEA-Acrylates Crosspolymers, Polymethyl vinyl ether/maleic anhydride copolymer, Polymethyl vinyl ether/maleic anhydride copolymer crosslinked with decadiene, Hydrolyzed Polymethyl vinyl ether/maleic anhydride copolymer, Hydrolyzed Polymethyl vinyl ether/maleic anhydride copolymer crosslinked with decadiene, Hydrolyzed Poly(t-butyl vinyl ether)/maleic anhydride copolymer crosslinked with decadiene, Hydrolyzed Polyethyl vinyl ether/maleic anhydride copolymer crosslinked with decadiene, Hydrolyzed Polystyrene/maleic anhydride copolymer crosslinked with decadiene, Hydrolyzed Polystyrene sulfonic acid/maleic anhydride copolymer crosslinked with decadiene and mixtures.

C. Cellulosic Polymers

Exemplary cellulosic polymers for use in the rheology modifying systems of the present invention include, but are not limited to, cellulose derivatives and modified cellulosic polymers, such as, for example, methyl cellulose, ethyl cellulose, hydroxyethyl cellulose, hydroxypropyl methyl cellulose, nitro cellulose, sodium cellulose sulfate, sodium carboxymethyl cellulose, crystalline cellulose, and cellulose powder. In some embodiments, the cellulosic polymers are crosslinked, and further comprise a crosslinking agent. One preferred cellulosic polymer suitable for use herein is hydroxypropyl methyl cellulose.

D. Synergistic Combinations

Applicant has discovered a number of synergistic combinations of clays with particular anionic polymers and cellulosic polymers. These combinations can provide desired viscosity and later profiles unobtainable with other rheology modifiers at the same inclusion level.

One combination includes a synthetic hectorite clay (e.g., laponite) with anionic polymers comprising cyclic alpha, beta unsaturated anhydrides and vinyl ether monomers (e.g., a crosslinked copolymer of maleic anhydride and vinyl methyl ether).

Another combination includes a synthetic hectorite clay with a crosslinked water-swellable polymer comprising cellulose ethers (e.g., hydroxypropyl methyl cellulose).

Synergistic results have been discovered where the individual components are included at levels of from about 0.01% to about 0.5%, by weight of the composition. In some embodiments, the preferred inclusion levels are from about 0.01% to about 0.25% and from about 0.01% to about 0.1%, by weight of the composition. Other inclusion levels may equally be suitable and effective depending on the product form, usage and desired end benefit.

### II. DETERSIVE SURFACTANTS

Compositions of the present invention include a detersive surfactant, including, for example, anionic detersive surfactants, zwitterionic or amphoteric detersive surfactants, or a combination thereof. The concentration of the detersive surfactant in the composition should be sufficient to provide the desired cleaning and lather performance, and generally range from about 1% to about 50%, and preferably from about 6% to about 24%, by weight of the composition. Exemplary embodiments of the present invention include the following upper limits for the surfactant level: 16%, 14%, 12%, and 10%. Lower limits for these exemplary embodiments include 6%.

A. Anionic Detersive Surfactants

Alkyl and alkyl ether sulfates are exemplary anionic surfactants for use in the present invention. These materials have the respective formulae ROSO₃M and RO(C2H₄O)xSO₃M, wherein R is alkyl or alkenyl of from about 8 to about 18 carbon atoms, x is an integer having a value of from 1 to 10, and M is a cation, such as ammonium, alkanolamines, such as triethanolamine, monovalent metals, such as sodium and potassium, and polyvalent metal cations, such as magnesium, and calcium.

The alkyl ether sulfates are typically made as condensation products of ethylene oxide and monohydric alcohols having from about 8 to about 24 carbon atoms. The alcohols can be synthetic or they can be derived from fats, e.g., coconut oil, palm kernel oil, tallow. Lauryl alcohol and straight chain alcohols derived from coconut oil or palm kernel oil are preferred. Such alcohols are reacted with from about 0 and about 10, preferably from about 2 to about 5, more preferably about 3, molar proportions of ethylene oxide, and the resulting mixture of molecular species having, for example, an average of 3 moles of ethylene oxide per mole of alcohol, is sulfated and neutralized.

Other suitable anionic detersive surfactants are the water soluble salts of organic, sulfuric acid reaction products conforming to the formula [R¹SO₃M] where R¹ is a straight or branched chain, saturated, aliphatic hydrocarbon radical having from about 8 to about 24, preferably from about 10 to about 18, carbon atoms; and M is a cation described hereinbefore.

Still other suitable anionic detersive surfactants are the reaction products of fatty acids esterified with isethionic acid and neutralized with sodium hydroxide where, for example, the fatty acids are derived from coconut oil or palm kernel oil; sodium or potassium salts of fatty acid amides of methyl tauride in which the fatty acids, for example, are derived from coconut oil or palm kernel oil. Other similar anionic surfactants are described in U.S. Pat. Nos. 2,486,921; 2,486,922; and 2,396,278.

Other anionic detersive surfactants suitable for use in the compositions are the succinnates, examples of which include disodium N-octadecylsulfosuccinnate; disodium lauryl sulfosuccinate; diammonium lauryl sulfosuccinate; tetrasodium N-(1,2-dicarboxyethyl)-N-octadecylsulfosuccinnate; diamyl ester of sodium sulfosuccinic acid; dihexyl ester of sodium sulfosuccinic acid; and dioctyl esters of sodium sulfosuccinic acid.

Other suitable anionic detersive surfactants include olefin sulfonates having from about 10 to about 24 carbon atoms. In addition to the true alkene sulfonates and a proportion of hydroxy alkanesulfonates, the olefin sulfonates can contain minor amounts of other materials, such as alkene disulfonates depending upon the reaction conditions, proportion of reactants, the nature of the starting olefins and impurities in the olefin stock and side reactions during the sulfonation process. A non-limiting example of such an alpha olefin sulfonate mixture is described in U.S. Pat. No. 3,332,880.

Another class of anionic detersive surfactants suitable for use in the compositions is the beta-alkyloxy alkane sulfonates. These surfactants conform to the below formula:

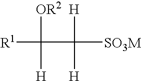

where R¹ is a straight chain alkyl group having from about 6 to about 20 carbon atoms, R² is a lower alkyl group having from about 1 to about 3 carbon atoms, preferably 1 carbon atom, and M is a water soluble cation as described hereinbefore.

Specific exemplary anionic detersive surfactants for use in the compositions include ammonium lauryl sulfate, ammonium laureth sulfate, triethylamine lauryl sulfate, triethylamine laureth sulfate, triethanolamine lauryl sulfate, triethanolamine laureth sulfate, monoethanolamine lauryl sulfate, monoethanolamine laureth sulfate, diethanolamine lauryl sulfate, diethanolamine laureth sulfate, lauric monoglyceride sodium sulfate, sodium lauryl sulfate, sodium laureth sulfate, potassium lauryl sulfate, potassium laureth sulfate, sodium lauryl sarcosinate, sodium lauroyl sarcosinate, lauryl sarcosine, cocoyl sarcosine, ammonium cocoyl sulfate, ammonium lauroyl sulfate, sodium cocoyl sulfate, sodium lauroyl sulfate, potassium cocoyl sulfate, potassium lauryl sulfate, triethanolamine lauryl sulfate, triethanolamine lauryl sulfate, monoethanolamine cocoyl sulfate, monoethanolamine lauryl sulfate, sodium tridecyl benzene sulfonate, sodium dodecyl benzene sulfonate, sodium cocoyl isethionate and combinations thereof.

B. Zwitterionic Detersive Surfactants

Zwitterionic detersive surfactants suitable for use in the compositions of the present invention are well known in the art, and include, but are not limited to, those surfactants broadly described as derivatives of aliphatic quaternary ammonium, phosphonium, and sulfonium compounds, in which the aliphatic radicals can be straight or branched chain, and wherein one of the aliphatic substituents contains from about 8 to about 18 carbon atoms and one contains an anionic group such as carboxy, sulfonate, sulfate, phosphate or phosphonate.

C. Amphoteric Detersive Surfactants

Amphoteric detersive surfactants suitable for use in the composition are well known in the art, and include, by way of example, those surfactants broadly described as derivatives of aliphatic secondary and tertiary amines in which the aliphatic radical can be straight or branched chain and wherein one of the aliphatic substituents contains from about 8 to about 18 carbon atoms and one contains an anionic group such as carboxy, sulfonate, sulfate, phosphate, or phosphonate. Specific exemplary detersive surfactants for use in the present invention include cocoamphoacetate, cocoamphodiacetate, lauroamphoacetate, lauroamphodiacetate, and mixtures thereof.

D. Other Detersive Surfactants

Compositions of the present invention may further comprise additional surfactants for use in combination with the anionic detersive surfactants described hereinbefore. Suitable optional surfactants include nonionic and cationic surfactants. Any such surfactant known in the art for use in hair or personal care products, for example, may be used, provided that the optional additional surfactant is also chemically and physically compatible with the essential components of the composition, or does not otherwise unduly impair product performance, aesthetics or stability. The concentration of the optional additional surfactants in the composition may vary with the cleansing or lather performance desired, the optional surfactant selected, the desired product concentration, the presence of other components in the composition, and other factors well known in the art.

Non limiting examples of other anionic, zwitterionic, amphoteric or optional additional surfactants suitable for use in the compositions are described in “McCutcheon's, Emulsifiers and Detergents,” 1989 Annual, published by M. C. Publishing Co., and U.S. Pat. Nos. 5,104,646; 5,106,609; 3,929,678; 2,658,072; 2,438,091; and 2,528,378.

### III. OPTIONAL COMPONENTS

Compositions of the present invention may include a broad range of additional components, depending on the product form and its intended use and end benefit. Individual concentrations of such optional components may range from about 0.001% to about 10%, for example.

Non-limiting examples of optional components for use in compositions of the present invention include cationic polymers, conditioning agents (hydrocarbon oils, fatty esters, silicones), humectants, anti dandruff agents, suspending agents, viscosity modifiers, pigments, dyes, nonvolatile solvents or diluents (water soluble and insoluble), pearlescent aids, foam boosters, antimicrobial agents, pediculocides, pH adjusting agents, perfumes, preservatives, chelating agents, proteins, skin active agents, sunscreens, UV absorbers, and vitamins.

In accordance with at least some of the embodiments of the present invention, the compositions are in the form of pourable liquids (under ambient conditions). These compositions will therefore typically comprise an aqueous carrier, which is present at a level of from about 20% to about 95%, and preferably from about 60% to about 85%. The aqueous carrier may comprise water, or a miscible mixture of water and an organic solvent. It should be noted that some detersive compositions of the present invention may be in solid form.

### IV. VISCOSITY AND LATHER PROFILES

Shampoos and body washes are two preferred product forms of the present invention; other detersive composition forms however are contemplated by the present invention. There are desired, albeit not required, viscosity and lather profiles associated with shampoo and body wash compositions of the present invention.

Exemplary compositional viscosity ranges include from about 7 Pa-sec to about 1,000 Pa-sec, from about 7 Pa-sec to about 20 Pa-sec, and from about 8 Pa-sec to about at 12 Pa-sec, when measured at a shear rate of 0.05 sec-1 and a temperature of 25° C. Viscosity is measured on a rheometer (Model AR 1000, TA Instruments). A coquette setup with a 1 mm gap is used to measure the viscosity across a shear rate of 0.01 to 1400 sec-1. Zero shear viscosity is recorded at 0.05 sec-1 in Pascal-seconds.

At least some of the preferred detersive compositions of the present invention manifest a lather index, as measured by The Modified Cylinder Lather Test method, of from about 1 to about 2. The Modified Cylinder Lather Test method is designed to evaluate lather speed and lather volume for personal care products. It is performed on 15 g/10″ flat Oriental virgin hair switches (commercially available from, for example, International Hair Importers & Products, Inc. of Glendale, N.Y.) that have been treated with 0.098 g of artificial liquid sebum (commercially available from, for example, Advance Testing Laboratory of Cincinnati, Ohio). A 0.75 cc volume of product (i.e., compositions of the present invention) is applied to the center of the switch. The lower portion of hair on the switch is then rubbed over the product on the hair 5× in a circular motion, followed by 40 strokes back and forth (total 80). Lather speed is recorded as the number of strokes when lather comes out significantly during the 80 strokes. Lather from both of the operator's gloves is placed into a graduated cylinder. Lather from hair is gathered using one downward stroke and is also placed into the cylinder. Lather volume is recorded. Three runs per test sample are performed and the mean of the three values is calculated. The average of three values is indexed against the average of three values obtained from the standard product described in Example 4 below.

### V. EXAMPLES

The following are non-limiting examples of the compositions of the present invention. The examples are given solely for the purpose of illustration and are not to be construed as limitations of the present invention, as many variations thereof are possible without departing from the spirit and scope of the invention, which would be recognized by one of ordinary skill in the art. In the examples, all concentrations are listed as weight percent, unless otherwise specified and may exclude minor materials such as diluents, filler, and so forth. The listed formulations, therefore, comprise the listed components and any minor materials associated with such components. As is apparent to one of ordinary skill in the art, the selection of these minors will vary depending on the physical and chemical characteristics of the particular ingredients selected to make the present invention as described herein.

### Examples 1-4

### Shampoo Examples

| | | | | 4 |
|---|---|---|---|---|
| | 1 | 2 | 3 | Control |
| Component | (wt %) | (wt %) | (wt %) | Shampoo |
| Water | Q.S. | Q.S. | Q.S. | Q.S. |
| Rheology modifying system, anionic | 0.0500 | 0.0500 | — | — |
| polymer MVE/MA crosslinked copolymer | | | | |
| (Stabileze 06) | | | | |
| Rheology modifying system, clay Hydrous | 0.0500 | 0.0500 | 0.05 | — |
| Na, Mg silicate (Laponite XLS) | | | | |
| Hydroxypropyl methylcellulose (PrimaFlo) | | | 0.1 | |
| Polyquaternium 10 (Ucare Polymer LR- | 0.5000 | 0.5000 | 0.5 | 0.5000 |
| 400) | | | | |
| Coconut monoethanolamide (Monamid CMA) | 1.0909 | 1.0286 | 1.0286 | 1.5000 |
| Disodium EDTA (Disslovine Na₂S) | 0.1400 | 0.1400 | 0.14 | 0.0991 |
| Sodium Benzoate (Purox S Grains) | 0.2500 | 0.2500 | 0.25 | 0.2500 |
| Sodium Citrate Dihydrate | 0.4520 | 0.4520 | 0.452 | 0.4520 |
| Sodium Laureth-3-Sulfate (SLE3S) | 2.1818 | | | — |
| Cocamidopropyl Betaine (Tegobetaine F-B) | 2.1818 | | | — |
| Sodium lauryl sulfate (SLS) | 6.5455 | | | — |
| Citric Acid | 0.0781 | | | 0.0400 |
| Sodium Chloride | 0.2500 | 0.7500 | 0.50 | 0.0145 |
| Sodium Hydroxide | 0.0126 | | | — |
| Dimethicone (Viscasil 3000,000) | 1.3510 | 1.3510 | 1.3510 | 1.3510 |
| Ammonium Laureth-3-Sulfate (AE3S) | 0.0676 | 4.1143 | 6.00 | 6.0000 |
| Ethylene glycol distearate (EGDS) | 1.5000 | 1.5000 | 1.5 | 1.5000 |
| Ammonium Lauryl Sulfate (ALS) | 1.5000 | 6.8751 | 6.8751 | 10.0000 |
| Methylchloroisothiazolinone & | 0.0005 | 0.0005 | 0.0005 | 0.0005 |
| Methylisothiazolinone (Kathon CG) | | | | |
| Fragrance | 0.7000 | 0.7000 | 0.7 | 0.7000 |
| PEG 7M (Polyox WSR-N-750) | 0.1000 | 0.1000 | 0.1 | 0.1000 |
| DL Panthenol 50% soln. (DL-Panthenol | 0.0300 | 0.0300 | 0.03 | 0.0300 |
| 50L) | | | | |
| DL Panthenyl Ethyl Ether (Pantyl Ethyl | 0.0300 | 0.0300 | 0.03 | 0.0300 |
| Ether) | | | | |
| Lysine Monochloride | 0.0280- | 0.0280 | 0.0280 | 0.0280 |
| L-Tyrosine Methylester Hydrochloride | 0.0138 | 0.0138 | 0.0138 | 0.0138 |
| (Methyl Tyrosine) | | | | |
| Histidine | 0.0080 | 0.0080 | 0.0080 | 0.0080 |
| Cetyl Alcohol | — | — | | 0.9000 |

Examples 1-4 can be prepared by conventional formulation and mixing techniques, such as described hereafter. Add the water into an appropriately sized and cleaned vessel. Begin stirring (stir speed ˜100-300 rpm) and heating to 60-65° C. Weigh the Laponite XLS into a plastic weigh-boat (by weight percent). Once the water temperature has reached 40° C., slowly add the Laponite to the water while continuing to heat and stir. Once the temperature has reached 60° C. to 65° C., hold the mixture at that temperature for approximately 5 minutes or until all of the Laponite is in solution. Weigh the CMEA into a plastic weigh boat and add to the Laponite/Water mixture while continuing to stir. Add the Disodium EDTA; Ammonium Laureth-3-Sulfate (SLE3S); and Ammonium Lauryl Sulfate (ALS); by weight percent. If needed, add the Sodium Chloride. If needed, add the Stabileze 06/Water dispersion and the UCARE Polymer LR-400/Water dispersion (See notes below) and continue to heat to 60° C. to 65° C. while mixing. Once the temperature of the mixture has reached 60° C. to 65° C., remove heat and continue mixing while allowing to cool. Add the Sodium Hydroxide (10% solution) if needed. Once the temperature has dropped below 55° C., add the Kathon CG while continuing to mix. If needed, add the HC Base/LP Base, fragrance, and other ingredients while continuing to mix. Mix until homogeneous. The final pH should be between 5.5 to 6.0. Adjust if necessary.
1) Note: If adding Stabileze 06 in addition to the Laponite XLS,—into a second appropriately sized and cleaned vessel add the distilled water. Set up for mixing using an appropriate laboratory stirrer. Begin mixing at an appropriate speed (200 rpm to 300 rpm). Slowly add the Stabileze 06 and mix until homogeneous.
2) Note: If adding UCARE Polymer LR-400 in addition to the Laponite XLS,—into a third appropriately sized and cleaned vessel add the distilled water. Set up for mixing using an appropriate laboratory stirrer. Begin mixing at an appropriate speed (50 rpm to 100 rpm). Slowly add the UCARE Polymer LR-400 and mix until homogeneous.

### Examples 5-7

### Personal Cleansing Compositions (e.g., Body Wash Products)

| | 5 | 6 | 7 |
|---|---|---|---|
| Ingredient | wt % | wt % | wt % |
| Ammonium Laureth-3 Sulfate | 3.0 | 4.1143 | — |
| Sodium Lauroamphoacetate | 8.0 | — | — |
| (Miranol L-32 Ultra from Rhodia) | | | |
| Ammonium Lauryl Sulfate | 1.0 | 6.8571 | — |
| Sodium Laureth-3-Sulfate (SLE3S) | — | — | 2.1818 |
| Cocamidopropyl betaine (Tegobetaine F-B) | — | — | 2.1818 |
| Sodium Lauryl Sulfate (SLS) | — | — | 6.5455 |
| Coconut monoethanolamide (CMEA) | — | 1.0286 | 1.0909 |
| Lauric Acid | 0.9 | 0.9 | 0.9 |
| Hydrous Na, Mg silicate (Laponite XLS) | 0.05 | 0.05 | 0.05 |
| MVE/MA crosslinked copolymer (Stabileze 06) | 0.05 | 0.05 | 0.05 |
| PEG 90M (Polyox WSR 301 from Dow | 0.1 | 0.1 | 0.2 |
| Chemical) | | | |
| Sodium Chloride | 0.3 | 0.3 | 0.3 |
| Sodium Benzoate | 0.25 | 0.25 | 0.25 |
| Disodium EDTA | 0.13 | 0.13 | 0.13 |
| Glydant | 0.37 | 0.37 | 0.37 |
| Citric Acid | 1.6 | 0.95 | 0.95 |
| Perfume | 0.5 | 0.5 | 0.5 |
| Expancel | 0.3 | 0.3 | 0.3 |
| (091 DE 40 d30 from Expancel, Inc.) | | | |
| Petrolatum (SuperWhite Protopet | 10 | 15 | 20 |
| from WITCO) | | | |
| Water | Q.S. | Q.S. | Q.S. |

Examples 5-7 can be prepared by conventional formulation and mixing techniques, such as follows: prepare a citric acid premix by adding citric acid in water at 1:3 ratio. Also, prepare a dispersion of the stabilize 06 in water. Then, add the water to the main mix vessel and heat to 40° C. Add the Laponite while continuing to heat to 60° C. Mix until clear. Add the following ingredients into the main mixing vessel with agitation: CMEA, ammonium lauryl sulfate, ammonium laureth-3 sulfate, Sodium laureth-3 sulfate; sodium lauryl sulfate; cocamidoproply betaine; citric acid premix, Miranol L-32 ultra, sodium chloride, sodium benzoate, disodium EDTA, lauric acid, Polyox WSR 301. Heat the vessel with agitation until it reaches 88° C., then add petrolatum. Mix for about 10 min. Cool the batch with a cold water bath with slow agitation until it reaches 43° C. Add the following ingredients: Glydant, perfume, and Expancel. Keep mixing until homogeneous.

### Examples 8-10

### Personal Cleansing Compositions

| | 8 | 9 | 10 |
|---|---|---|---|
| Ingredient | Wt % | wt % | wt % |
| Miracare SLB-365 (from Rhodia) | 12.00 | — | — |
| (Sodium Trideceth Sulfate, Sodium | | | |
| Lauroamphoacetate, Cocamide MEA) | | | |
| Ammonium Laureth-3 Sulfate (AE3S) | — | 4.1143 | — |
| Ammonium Lauryl Sulfate (ALS) | — | 6.8571 | — |
| Sodium Laureth-3-Sulfate | — | — | 2.1818 |
| Sodium Lauryl Sulfate | — | — | 6.5455 |
| Cocamidopropyl betaine (Tego Betaine F-B) | — | — | 2.1818 |
| Coconut monoethanolamide (CMEA) | — | 1.0286 | 1.0909 |
| Hydrous Na, Mg silicate (Laponite XLS) | 0.05 | 0.05 | 0.05 |
| Hydroxyproply methyl cellulose (PrimaFlo | 0.10 | 0.10 | 0.10 |
| MP3295A) | | | |
| PEG 90M (Polyox WSR 301 from Dow | 0.16 | 0.14 | 0.05 |
| Chemical) | | | |
| Sodium Chloride | 2.8 | 2.45 | 1.75 |
| Disodium EDTA | 0.1 | 0.1 | 0.1 |
| Sodium Benzoate | 0.16 | 0.16 | 0.16 |
| Glydant | 0.26 | 0.26 | 0.26 |
| Citric Acid | 0.4 | 0.4 | 0.4 |
| Perfume | 1.0 | 1.0 | 1.0 |
| Expancel | 0.32 | 0.28 | 0.2 |
| (091 DE 40 d30 from Expancel, Inc.) | | | |
| G2218 Petrolatum (from WITCO) | 18 | — | — |
| Petrolatum (Superwhite Protopet from | — | 18 | 30 |
| WITCO) | | | |
| Mineral Oil (Hydrobrite 1000 PO White | 12 | 12 | 20 |
| MO from WITCO) | | | |
| Water | Q.S. | Q.S. | Q.S. |
| pH adjustment (citric acid or NaOH) | (6.0) | (6.0) | (6.0) |

Examples 8-10 can be prepared by conventional formulation and mixing techniques, such as follows: first prepare a citric acid premix by adding citric acid into water at 1:3 ratio. Then, add the following ingredients into the main mixing vessel in the following sequence with agitation: water and heat to 40° C., Laponite while continuing to heat to 60° C. Mix until clear. Add the following ingredients into the main mixing vessel with agitation: CMEA, Expancel, Polyox WSR 301, and Miracare SLB-365; Ammonium Laureth-3-3-sulfate; ammonium lauryl sulfate; sodium laureth-3-sulfate; sodium lauryl sulfate; cocamidopropyl betaine and primaflo MP3295A. Adjust the pH to 6.0 using citric acid premix. Then, add sodium chloride, disodium EDTA, sodium benzoate, glydant, and perfume. In a separate vessel, prepare a lipid premix by adding Petrolatum into Mineral oil and heat to 88° C. Cool the lipid premix to 38° C. and add into the main batch. Adjust pH to 6.0. Keep mixing until homogeneous.

### Examples 11-13

### Personal Cleansing Compositions

| | 11 | 12 | 13 |
|---|---|---|---|
| Ingredient | wt % | wt % | wt % |
| Sodium Trideceth Sulfate | 5.9 | 5.9 | 4 |
| (Cedepal TD-407 from Stepan) | | | |
| Ammonium Lauryl Sulfate | 5.9 | 5.9 | 4 |
| Sodium Lauroamphoacetate | 3.5 | 3.5 | 2.3 |
| (Miranol L-32 Ultra from Rhodia) | | | |
| Guar Hydroxypropyltrimonium Chloride | 0.45 | 0.45 | 0.3 |
| (N-Hance 3196 from Aqualon) | | | |
| PEG 90M (Polyox WSR 301 from Dow | 0.11 | 0.11 | 0.08 |
| Chemical) | | | |
| Isosteareth-2 (from Global Seven) | 0.75 | 0.75 | 0.5 |
| Xanthan Gum (Keltrol 1000 from CP Kelco) | 0.15 | 0.15 | 0.1 |
| Sodium Chloride | 2.6 | 2.6 | 1.75 |
| Disodium EDTA | 0.1 | 0.1 | 0.1 |
| Sodium Benzoate | 0.16 | 0.16 | 0.16 |
| Glydant | 0.3 | 0.3 | 0.3 |
| Citric Acid | 0.3 | 0.3 | 0.3 |
| Perfume | 1.0 | 1.0 | 1.0 |
| Expancel | 0.3 | 0.3 | 0.2 |
| (091 WE 40 d24 from Expancel, Inc.) | | | |
| G2218 Petrolatum (from WITCO) | 18 | — | — |
| Petrolatum (Superwhite Protopet from | — | 18 | 30 |
| WITCO) | | | |
| Mineral Oil (Hydrobrite 1000 PO White | 12 | 12 | 20 |
| MO from WITCO) | | | |
| Water | Q.S. | Q.S. | Q.S. |
| pH adjustment (citric acid or NaOH) | (6.0) | (6.0) | (6.0) |

Examples 11-13 can be prepared by conventional formulation and mixing techniques, such as follows: first prepare a citric acid premix by adding citric acid into water at 1:3 ratio and a polymer premix by adding Polyox WSR 301 and Keltrol 1000 into isosteareth-2. Then, add the following ingredients into the main mixing vessel with agitation: water, N-Hance 3196, sodium trideceth sulfate, sodium lauroamphoacetate, citric acid premix, ammonium lauryl sulfate. Then add polymer premix (polyox and Keltrol 1000 in isosteareth-2). Add sodium chloride, disodium EDTA, sodium benzoate, glydant, and perfume. In a separate vessel, prepare a lipid premix by adding Petrolatum into Mineral oil and heat to 88° C. Cool the lipid premix to 38° C. and then add into the main batch. Adjust pH to 6.0. Keep agitation until homogeneous.

### Example 14-15

### Personal Cleansing Compositions

| | 14 | 15 |
|---|---|---|
| Ingredient | (wt %) | (wt %) |
| Sodium Lauroamphoacetate | 4.8 | 2.4 |
| (Cognis Chemical Corp.,) | | |
| Sodium Trideceth Sulfate | 8.1 | 4.0 |
| (sulfated from Iconol TDA-3 (BASF Corp.) | | |
| to >95% sulfate) | | |
| Sodium Lauryl Sulfate | 8.1 | 4.0 |
| Trideceth-3 | 2 | 1 |
| (Iconal TDA-3 from BASF Corp.) | | |
| Sodium Chloride | 4.75 | 2.5 |
| Guar hydroxypropyltrimonium chloride | 0.6 | 0.3 |
| (N-Hance 3196 Polymer) | | |
| PEG 90M | 0.15 | 0.08 |
| (Polyox WSR301) | | |
| Xanthan gum (Keltrol 1000, Kelco Corp.) | 0.2 | 0.1 |
| Methyl chloro isothiazolinone and methyl | 0.033 | 0.033 |
| isothiazolinone (Kathon CG, Rohm & Haas) | | |
| EDTA (Dissolvine NA 2x) | 0.15 | 0.15 |
| Sodium Benzoate | 0.2 | 0.2 |
| Citric Acid, titrate | pH = | pH = 5.7 ± 0.2 |
| | 5.7 ± 0.2 | |
| Perfume | 1.0 | 1.0 |
| Water | Q.S. | Q.S. |

Examples 14-15 can be prepared by conventional formulation and mixing techniques, such as follows: add citric acid into water at 1:3 ratios to form a citric acid premix. Prepare a polymer premix by adding Polyox WSR301 and Xanthan Gum into Trideceth-3. Then, add the following ingredients into the main mixing vessel in the following sequence with agitation: water, N-Hance polymer, sodium lauroamphoacetate, sodium trideceth sulfate, sodium lauroamphoacetate, sodium lauryl sulfate, sodium chloride, sodium benzoate, and Disodium EDTA. Add citric acid premix to adjust pH to 5.7±0.2. Add the polymer premix into the main mixing vessel with continuous agitation. Add perfume while continuing to agitate until homogeneous.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm”.

All documents cited in the Detailed Description of the Invention are, in relevant part, incorporated herein by reference; the citation of any document is not to be construed as an admission that it is prior art with respect to the present invention. To the extent that any meaning or definition of a term in this written document conflicts with any meaning or definition of the term in a document incorporated by reference, the meaning or definition assigned to the term in this written document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A detersive composition, comprising:
(a) a surfactant; and
(b) a rheology modifying system comprising the combination of a hectorite clay, and a polymer comprising cyclic alpha, beta unsaturated anhydrides and vinyl ether monomers.

2. The composition of claim 1, wherein the hectorite clay comprises sodium magnesium silicate and tetrasodium phosphate.

3. The composition of claim 1, wherein the polymer is crosslinked with a crosslinker comprising 1,9-decadiene.

4. The composition of claim 1, wherein the polymer comprises a crosslinked copolymer of maleic anhydride and vinyl methyl ether.

5. The composition of claim 1, wherein the composition comprises a total surfactant level of from about 6% to about 24%, by weight of the composition.

6. The composition of claim 1, wherein the composition comprises a total surfactant level that is less than or equal to about 16% by weight of the composition.

7. The composition of claim 1, wherein the composition comprises a total surfactant level that is less than or equal to about 14% by weight of the composition.

8. The composition of claim 1, wherein the composition comprises a total surfactant level that is less than or equal to about 12% by weight of the composition.

9. The composition of claim 1, wherein the composition comprises a total surfactant level that is less than or equal to about 10% by weight of the composition.

10. The composition of claim 1, wherein the surfactant is selected from the group consisting of anionic surfactants, zwitterionic surfactants, and amphoteric surfactants.

11. The composition of claim 1, wherein the composition has a lather index of between about 1 and about 2.

12. The composition of claim 1, wherein the composition has a viscosity of from about 7 Pa-sec to about 1,000 Pa-sec at a shear rate of 0.05 sec-1, and measured at 25° C.

13. The composition of claim 1, wherein the composition has a viscosity of from about 7 Pa-sec to about 20 Pa-sec at a shear rate of 0.05 sec-1, and measured at 25° C.

14. The composition of claim 1, wherein the composition has a viscosity of from about 8 Pa-sec to about 12 Pa-sec at a shear rate of 0.05 sec-1, and measured at 25° C.

15. The composition of claim 1, wherein the composition is a shampoo.

16. The composition of claim 11, wherein the composition is a body wash product.

17. The composition of claim 1, wherein each of the polymer and the hectorite clay is included in an amount from about 0.01% to about 0.5% by weight of the composition.

18. The composition of claim 1, wherein each of the polymer and the hectorite clay is included in an amount from about 0.01% to about 0.25% by weight of the composition.

19. The composition of claim 1, wherein each of the polymer and the hectorite clay is included in an amount from about 0.01% to about 0.1% by weight of the composition.

20. A detersive composition, comprising:
(a) a surfactant; and
(b) a rheology modifying system comprising a combination of a hectorites clay, and a water-swellable polymer comprising cellulose ethers.

21. The composition of claim 20, wherein the hectorite clay comprises sodium magnesium silicate and tetrasodium phosphate.

22. The composition of claim 20, wherein the polymer comprises hydroxypropyl methyl cellulose.

23. The composition of claim 20, wherein the composition comprises a total surfactant level that is less than or equal to about 16% by weight of the composition.

24. The composition of claim 20, wherein the composition comprises a total surfactant level that is less than or equal to about 14% by weight of the composition.

25. The composition of claim 20, wherein the composition comprises a total surfactant level that is less than or equal to about 12% by weight of the composition.

26. The composition of claim 20, wherein the composition comprises a total surfactant level that is less than or equal to about 10% by weight of the composition.

27. The composition of claim 20, wherein the surfactant is selected from the group consisting of anionic surfactants, zwitterionic surfactants, and amphoteric surfactants.

28. The composition of claim 20, wherein the composition has a lather index of between about 1 and about 2.

29. The composition of claim 20, wherein the composition has a viscosity of from about 7 Pa-sec to about 1,000 Pa-sec at a shear rate of 0.05 sec-1, and measured at 25° C.

30. The composition of claim 20, wherein the composition has a viscosity of from about 7 Pa-sec to about 20 Pa-sec at a shear rate of 0.05 sec-1, and measured at 25° C.

31. The composition of claim 20, wherein the composition has a viscosity of from about 8 Pa-sec to about 12 Pa-sec at a shear rate of 0.05 sec-1, and measured at 25° C.

32. The composition of claim 20, wherein the composition is a shampoo.

33. The composition of claim 20, wherein the composition is a body wash product.

34. The composition of claim 20, wherein each of the polymer and the hectorite clay is included in an amount from about 0.01% to about 0.5% by weight of the composition.

35. The composition of claim 20, wherein each of the polymer and the hectorite clay is included in an amount from about 0.01% to about 0.25% by weight of the composition.

36. The composition of claim 20, wherein each of the polymer and the hectorite clay is included in an amount from about 0.01% to about 0.1% by weight of the composition.

37. A detersive composition, comprising:
(a) a surfactant; and
(b) a rheology modifying system comprising a combination of a clay with an anionic polymer or a cellulosic polymer,
wherein the composition comprises a total surfactant level of less than or equal to about 14% by weight of the composition, and
wherein the composition has a viscosity of from about 7 Pa-sec to about 1,000 Pa-sec at a shear rate of 0.05 sec-1, and measured at 25° C.

38. The composition of claim 37, wherein the rheology modifying system comprises the combination of a clay with an anionic polymer, the anionic polymer comprising cyclic alpha, beta unsaturated anhydrides and vinyl ether monomers.

39. The composition of claim 37, wherein the rheology modifying system comprises the combination of a clay with an anionic polymer, the anionic polymer comprising a copolymer of maleic anhydride and vinyl methyl ether.

40. The composition of claim 37, wherein the rheology modifying system comprises the combination of a clay with a cellulosic polymer, the cellulosic polymer comprising hydroxypropyl methylcellulose.

41. The composition of claim 37, wherein the clay comprises a synthetic hectorite clay.

42. The composition of claim 37, wherein the clay comprises sodium magnesium silicate and tetrasodium phosphate.

43. The composition of claim 39, wherein the clay comprises a synthetic hectorite clay.

44. The composition of claim 40, wherein the clay comprises a synthetic hectorite clay.

45. The composition of claim 37, wherein the composition comprises a total surfactant level of less than or equal to about 12% by weight of the composition.

46. The composition of claim 37, wherein the composition comprises a total surfactant level of less than or equal to about 10% by weight of the composition.

47. The composition of claim 37, wherein the composition is a shampoo.

48. The composition of claim 37, wherein the composition is a body wash product.

49. The composition of claim 37, wherein the composition has a viscosity of from about 7 Pa-sec to about 20 Pa-sec at a shear rate of 0.05 sec-1, and measured at 25° C.

50. The composition of claim 37, wherein the composition has a viscosity of from about 8 Pa-sec to about 12 Pa-sec at a shear rate of 0.05 sec-1, and measured at 25° C.

51. The composition of claim 37, wherein the composition has a lather index of from about 1 to about 2.

52. A detersive composition, comprising:
(a) a surfactant;
(b) a rheology modifying system comprising a combination of a clay with an anionic polymer or a cellulosic polymer, the clay and the polymer collectively included in an amount of from about 0.1% to about 1% by weight of the composition,
wherein the composition has a viscosity of from about 7 Pa-sec to about 1,000 Pa-sec at a shear rate of 0.05 sec-1, and measured at 25° C.

53. The composition of claim 52, wherein the clay and the polymer are collectively included in an amount of from about 0.1% to about 0.5% by weight of the composition.

54. The composition of claim 52, wherein the rheology modifying system comprises a combination of a clay with an anionic polymer, the clay comprising a synthetic hectorite clay, and the anionic polymer comprises a copolymer of maleic anhydride and vinyl methyl ether.

55. The composition of claim 52, wherein the rheology modifying system comprises a combination of a clay with a cellulosic polymer, the clay comprising a synthetic hectorite clay, and the cellulosic polymer comprising hydroxypropyl methylcellulose.

56. The composition of claim 52, wherein the composition is a shampoo.

57. The composition of claim 52, wherein the composition is a body wash product.

58. The composition of claim 52, wherein the composition has a viscosity of from about 7 Pa-sec to about 20 Pa-sec at a shear rate of 0.05 sec-1, and measured at 25° C.

59. The composition of claim 52, wherein the composition has a viscosity of from about 8 Pa-sec to about 12 Pa-sec at a shear rate of 0.05 sec-1, and measured at 25° C.

60. The composition of claim 52, wherein the composition has a lather index of from about 1 to about 2.

61. A detersive composition, comprising:
(a) a surfactant; and
(b) a rheology modifying system comprising a combination of a clay with an anionic polymer or a cellulosic polymer,
wherein the composition comprises a total surfactant level of less than or equal to about 14% by weight of the composition,
wherein the composition has a viscosity of from about 7 Pa-sec to about 1,000 Pa-sec at a shear rate of 0.05 sec-1, and measured at 25° C., and
wherein the composition has a lather index of from about 1 to about 2.

62. A rheology modifying system for use in a detersive composition, the system comprising a combination of a synthetic hectorite clay, and a polymer comprising cyclic alpha, beta unsaturated anhydrides and vinyl ether monomers.

63. The system of claim 62, wherein the synthetic hectorite clay comprises sodium magnesium silicate and tetrasodium phosphate.

64. The system of claim 62, wherein the polymer comprises a crosslinked copolymer of maleic anhydride and vinyl methyl ether.

65. A rheology modifying system for use in a detersive composition, the system comprising a combination of a synthetic hectorite clay, and a water-swellable polymer comprising cellulose ethers.

66. The composition of claim 65, wherein the synthetic hectorite clay comprises sodium magnesium silicate and tetrasodium phosphate.

67. The composition of claim 65, wherein the polymer comprises hydroxypropyl methyl cellulose.
